(19) United States
(12) Patent Application Publication
(10) Pub. No.: US 2026/0195168 A1
(43) Pub. Date: Jul. 9, 2026

(54) HYBRID INTERRUPT PROCESSING DEVICE AND METHOD

(71) Applicant: Kookmin University Industry Academy Cooperation Foundation, Seoul (KR)

(72) Inventor: Yongsoo JOO, Seoul (KR)

(73) Assignee: Kookmin University Industry Academy Cooperation Foundation, Seoul (KR)

(21) Appl. No.: 19/133,445

(22) PCT Filed: May 12, 2023
(86) PCT No.: PCT/KR2023/006460

§ 371 Date: May 28, 2025

(30) Foreign Application Priority Data
Dec. 15, 2022 (KR) 10-2022-0176263
May 9, 2023 (KR) 10-2023-0060042

(51) Int. Cl. G06F 9/48

(52) U.S. Cl. CPC G06F 9/4825

(57) ABSTRACT

The present disclosure relates to a hybrid interrupt processing device and method. The device includes a task interrupt setting unit that sets reception of a device interrupt generated by an input/output device and reception of a sleep timer interrupt during a process of issuing a task command to the input/output device, a task processing standby unit that waits for the occurrence of the device interrupt and the sleep timer interrupt, and an input/output processing unit that completes task processing according to the task command through a first-received interrupt event—either the device interrupt or the sleep timer interrupt—and blocks the second interrupt event that has not yet occurred.

### TECHNICAL FIELD

The present disclosure relates to an interrupt processing technology, and more specifically, relates to a hybrid interrupt processing device and method, which can detect task completion based on an interrupt event occurring beforehand in a device interrupt and a sleep timer interrupt during a task processing procedure according to a task command to the input/output device.

### BACKGROUND ART

Since an input/output (I/O) speed of a storage device is very slow compared to a central processing unit (CPU), interrupt techniques have traditionally been used to detect completion of I/O of the storage device. An I/O request processor transmits an I/O command to the storage device, thereafter, switches to an idle state, and waits. When the I/O is completed and the storage device generates an interrupt, the process wakes up and resumes the task. A latency caused by context switching and an interrupt handler, which occur in this process, varies from system to system. However, the latency is generally known to be 1.5 μs to 2 μs.

A hard disk drive (HDD) in the related art takes at least several milliseconds to perform the I/O command, and a minimum latency of a currently widely used NAND flash-based solid state drive (SSD) also exceeds several tens of microseconds. Therefore, I/O performance is not significantly affected by overhead resulting from the interrupt. However, an I/O latency of low-latency SSD is as short as 5 to 7 microseconds, and thus, a delay overhead ratio of the interrupt becomes very high. Therefore, polling has been proposed as a method to avoid this problem. According to a polling technique, an I/O request process is operated by using a method for repeatedly checking whether the I/O is completed, without being switched to the idle state. Therefore, immediately after detecting the I/O completion, the I/O request process can quickly return to the original process without going through context switching.

FIG. 1 is a view illustrating an operation method for detecting I/O completion of a storage device in the related art.

FIG. 1(a) illustrates the operation method of the interrupt. An interrupt method releases CPU occupancy immediately after I/O submission and allocates the CPU to another process through task scheduling. When there is no executable process, the CPU enters an idle state. When the interrupt occurs at the time of I/O completion in the storage device (for example, the SSD), the CPU returns to the block layer of a kernel through an interrupt service routine (ISR), completes I/O processing, and resumes the original user process in which the I/O was generated.

FIG. 1(b) illustrates an operation method of classic polling. Unlike the interrupt illustrated in FIG. 1(a), a polling method performs a polling operation of repeatedly checking whether the I/O of the storage device is completed, without releasing CPU occupancy after I/O submission. Therefore, there is no delay due to context switching and ISR execution at the time of I/O completion. Despite the performance advantage of the polling technique, the polling technique has the disadvantage that CPU usage rate reaches 100%. In order to compensate for this disadvantage while maintaining the advantage of the polling technique, a hybrid polling technique has been proposed.

FIGS. 1(c) and 1(d) illustrate an operation method of hybrid polling. The hybrid polling calls a sleep timer function instead of performing polling immediately after the I/O command is transmitted, switches to the idle state for a predetermined time, and starts polling immediately after the process wakes up from a timer interrupt. Therefore, a poll duration can be reduced by a sleep time, and thus, the CPU usage can be reduced while the same I/O performance as the polling technique illustrated in FIG. 1(b) can be secured. A key to the hybrid polling technique is to appropriately determine the sleep duration so that the hybrid polling can wake up immediately before the I/O completion. However, since the I/O processing time of the storage device is not fixed but dynamically varies depending on multiple factors, it is not easy to obtain an optimal I/O sleep duration by accurately predicting the I/O processing time. In the case of undersleep, where the process wakes up too early from sleep, as in FIG. 1(c), the poll duration is lengthened that much, and the advantageous effect of reducing the CPU usage is reduced. On the other hand, in the case of oversleep, where the process wakes up later than the I/O completion, as in FIG. 1(d), the I/O performance is accordingly degraded.

According to a sleep duration determination algorithm of the hybrid polling currently implemented in the Linux operating system, an average processing time of the I/O command occurring during the previous 100 milliseconds is obtained, and half of the average processing time is used as the sleep time. Therefore, it can be expected to show the same I/O performance as the polling technique while the CPU usage is reduced to approximately 50%. However, when the I/O latency of the storage device changes due to a sudden change in workload, the hybrid polling may either cause excessive undersleeping, failing to reduce CPU usage, or cause excessive oversleeping, exhibiting a vulnerable point where the I/O performance is degraded compared to the interrupt.

FIG. 2 is a view illustrating a hybrid polling operation log. It can be understood that 4 μs—half of the average I/O latency of 8 μs—is used as the sleep request time, and the actual total sleep duration is approximately 6 μs, due to timer interrupt ISR execution and context switching overhead. Here, (a) represents the I/O time, (b) represents the requested sleep time, and (c) represents the actual sleep time, respectively.

In FIG. 2(a), when the latency of the storage device is suddenly increases, undersleep occurs. Accordingly, the hybrid polling unnecessarily performs polling for a long time, and CPU usage increases. On the other hand, in FIG. 2(b), when the hybrid polling does not wake up immediately after the time requested by the sleep timer and its return is delayed, unintended oversleep occurs. The unintended oversleep increases not only the average I/O latency but also the tail latency. Consequently, the service quality of the storage device is degraded.

### PRIOR ART DOCUMENT

### Patent Document

Korean Patent No. 10-2418991 (2022 Jul. 5)

### DETAILED DESCRIPTION OF INVENTION

### Technical Problems

One embodiment of the present disclosure provides a hybrid interrupt processing device and method capable of detecting task completion based on the first-received interrupt event—either a device interrupt or a sleep timer interrupt—during the task processing procedure according to a task command to the input/output device.

One embodiment of the present disclosure provides a hybrid interrupt processing device and method that employs both interrupt and hybrid polling techniques during the processing of input/output (I/O) commands of a storage device, thereby preventing excessive undersleeping and oversleeping in hybrid polling and effectively suppressing increases in CPU usage, degradation of I/O performance, and increases in tail latency—all caused by inaccurate sleep duration prediction in hybrid polling.

One embodiment of the present disclosure provides a hybrid interrupt processing device and method that sets both a device interrupt for an input/output device and a sleep timer interrupt to complete a task based on the first-received interrupt event, and prevents an unnecessary call of an interrupt service routine by blocking the interrupt event that has not yet occurred.

### Technical Solution

According to embodiments, a hybrid interrupt processing device includes: a task interrupt setting unit that sets the reception of a device interrupt generated by an input/output device and the reception of a sleep timer interrupt during the process of issuing a task command to an input/output device; a task processing standby unit that waits for the occurrence of the device interrupt and the sleep timer interrupt; and an input/output processing unit that completes the task processing according to the task command based on the first-received interrupt—either the device interrupt or the sleep timer interrupt—and blocks the second interrupt event that has not yet occurred.

The task interrupt setting unit may first set the reception of the device interrupt, then set the reception of the sleep timer interrupt, and finally initiate sleep.

The task processing standby unit may wait for the occurrence of the device interrupt and the sleep timer interrupt, and then deliver the first-received interrupt event—either the device interrupt or the sleep timer interrupt—to the input/output processing unit.

When the first-received interrupt event is the device interrupt, the input/output processing unit may cancel the pending sleep timer interrupt that would otherwise trigger the second interrupt event.

When the device interrupt is received before the sleep timer interrupt occurs, the input/output processing unit may cancel the sleep timer and then complete the task command, thereby preventing a call of the sleep timer interrupt service routine.

When the first-received interrupt event is the sleep timer interrupt, the input/output processing unit may disable the reception of the device interrupt corresponding to the second interrupt event.

When the first-received interrupt event is the sleep timer interrupt, the input/output processing unit may issue a cancellation command for the device interrupt—corresponding to the second interrupt event—to the input/output device.

When the first-received interrupt event is the sleep timer interrupt, the input/output processing unit may perform polling to check whether the task of the input/output device has been completed.

When the maximum poll duration elapses, the input/output processing unit may stop polling and re-enable the reception of the device interrupt.

According to embodiments, a hybrid interrupt processing method includes: a task interrupt setting step that sets the reception of a device interrupt generated by an input/output device and the reception of a sleep timer interrupt during the process of issuing a task command to an input/output device; a task processing standby step of waiting for the occurrence of the device interrupt and the sleep timer interrupt; and an input/output processing step that completes the task processing according to the task command based on the first-received interrupt—either the device interrupt or the sleep timer interrupt—and blocks the second interrupt event that has not yet occurred.

In the task interrupt setting step, reception of the device interrupt may be set first, followed by setting reception of the sleep timer interrupt, after which sleep may be initiated.

In the task processing standby step, the system may wait for the occurrence of the device interrupt and the sleep timer interrupt, and then deliver the first-received interrupt event to the input/output processing unit.

In the input/output processing step, if the first-received interrupt event is the device interrupt, the sleep timer interrupt associated with the second interrupt event may be cancelled.

In the input/output processing step, if the first-received interrupt event is the sleep timer interrupt, reception of the device interrupt associated with the second interrupt event may be disabled.

In the input/output processing step, if the first-received interrupt event is the sleep timer interrupt, a cancellation command for the device interrupt associated with the second interrupt event may be provided to the input/output device.

In the input/output processing step, if the first-received interrupt event is the sleep timer interrupt, polling may be performed to determine whether the task of the input/output device has been completed.

In the input/output processing step, if the maximum poll duration elapses, the polling may be stopped, and the reception of the device interrupt may be re-enabled.

### Effect of Invention

The disclosed technology may have the following advantageous effects. However, it does not mean that a specific embodiment has to include all of the following advantageous effects or has to include only the following advantageous effects, and thus, the scope of the disclosed technology should not be construed as being limited thereby.

The hybrid interrupt processing device and method according to one embodiment of the present disclosure may detect task completion based on the first-received interrupt event-either the device interrupt or the sleep timer interrupt-during the task processing procedure according to a task command to the input/output device.

The hybrid interrupt processing device and method according to one embodiment of the present disclosure may prevent excessive undersleep and oversleep in hybrid polling by employing both interrupt and hybrid polling techniques during the processing of input/output (I/O) commands of the storage device, thereby effectively suppressing increases in CPU usage, degradation of I/O performance, and increases in tail latency-all caused by inaccurate sleep duration prediction in hybrid polling.

The hybrid interrupt processing device and method according to one embodiment of the present disclosure may set both the device interrupt of the input/output device and the sleep timer interrupt to complete the task based on the first-received interrupt event, and may prevent an unnecessary call of an interrupt service routine by blocking the interrupt event that has not yet occurred.

### BRIEF DESCRIPTION OF THE DRAWING

FIG. 1 is a view illustrating an operation method for detecting I/O completion of a storage device in the related art.

FIG. 2 is a view illustrating a hybrid polling operation log.

FIGS. 3a to 3c are views describing the operation flows of interrupt, polling, and hybrid polling.

FIG. 4 is a view illustrating a hybrid interrupt processing system according to the present disclosure.

FIG. 5 is a view describing a functional configuration of the hybrid interrupt processing device shown in FIG. 4.

FIG. 6 is a flowchart describing a hybrid interrupt processing method according to the present disclosure.

FIG. 7 is a view illustrating an example of a hybrid interrupt processing procedure according to the present disclosure.

FIGS. 8a to 8d are views describing operations of each interrupt processing method shown in FIG. 7.

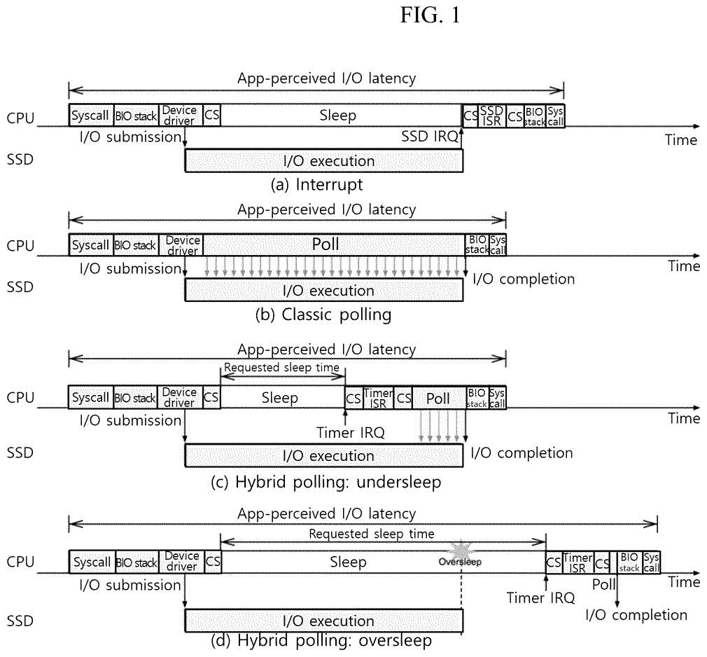

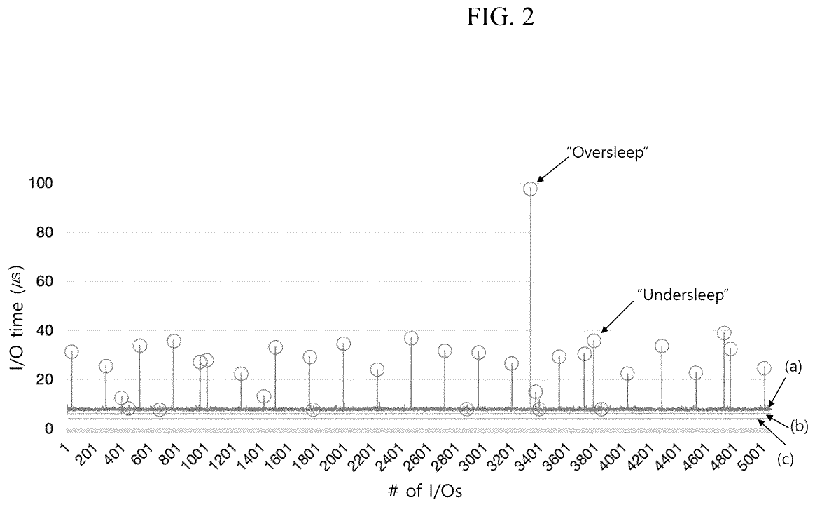

### BEST MODE FOR CARRYING OUT THE INVENTION

Specific structural or functional descriptions in the embodiments of the present disclosure introduced in this specification or application are only for description of the embodiments of the present disclosure. The descriptions should not be construed as being limited to the embodiments described in the specification or application. The present disclosure may, however, be embodied in many different forms, but should be construed as covering modifications, equivalents or alternatives falling within ideas and technical scopes of the present disclosure. Further, since effects disclosed herein do not mean that a specific embodiment should include all or only the effects, the scope of the present disclosure should not be construed as being limited thereto.

Meanwhile, the meaning of terms described herein will be understood as follows.

It will be understood that, although the terms “first”, “second”, etc. may be used herein to distinguish one element from another element, these elements should not be limited by these terms. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In each step, reference characters (e.g. a, b, c, etc.) are used for the convenience of description. The reference characters do not designate the order of the steps, and the steps may be performed in a different order unless the context clearly indicates otherwise. That is, the steps may be performed in the specified order, may be performed substantially simultaneously, or may be performed in a reverse order.

The present disclosure can be implemented as a computer-readable code on a computer-readable recording medium. The computer-readable recording medium includes all types of recording devices in which data readable by a computer system is stored. Examples of the computer-readable recording medium include ROM, RAM, CD-ROM, magnetic tape, floppy disk, an optical data storage device, etc. In addition, the computer-readable recording medium may be distributed in a computer system connected via a network, so that computer-readable codes may be stored and executed in a distributed manner.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

An interrupt has been the de facto standard for detecting I/O completion of a storage device, since it can effectively handle the speed difference between memory and the HDD. Even after SSDs began to significantly replace HDDs, the preference for interrupts remained largely unchanged. However, the situation has changed as the latest SSDs offer not only high capacity and high transfer bandwidth, but also extremely low I/O latency. In particular, an ultra-low-latency (ULL) SSD may complete an I/O task within tens of microseconds. This low latency further highlights the overhead of interrupts due to context switching, cache corruption, and CPU power state switching latency.

Polling is considered an alternative to avoid the overhead of interrupts described above. Polling has the potential to fully utilize the raw performance of ULL SSDs but has a fatal weakness in that CPU usage reaches 100% until the I/O is completed. Hybrid polling has been proposed as a solution to this weakness of polling.

Hybrid polling operates such that the process sleeps during the first portion of an I/O processing time, then wakes up, and polling is performed only during the remaining portion until the I/O is completed. As a result, the efficiency of the hybrid polling is determined based on the accuracy of estimating when the current I/O will complete. Ideally, it is most preferable that the process to wake up from sleep immediately before I/O completion, but this configuration is not feasible since the future cannot be perfectly predicted. In practice, the process may wake up too early from sleep, increasing CPU usage, or too late, increasing the I/O latency perceived by the application.

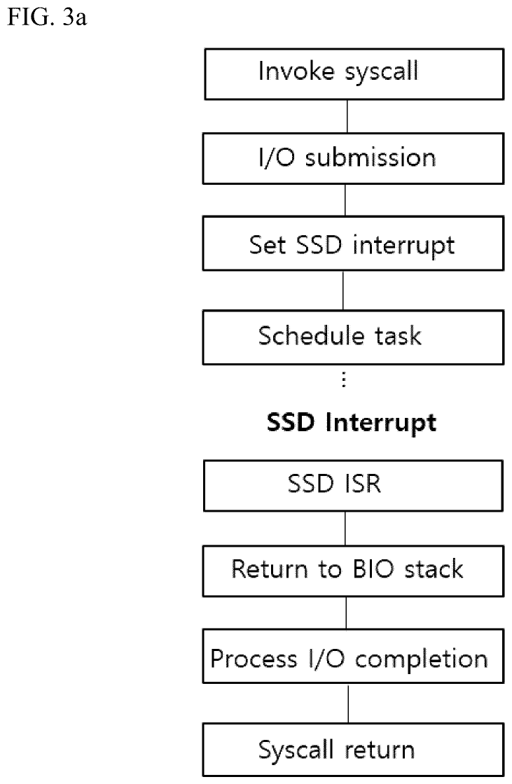

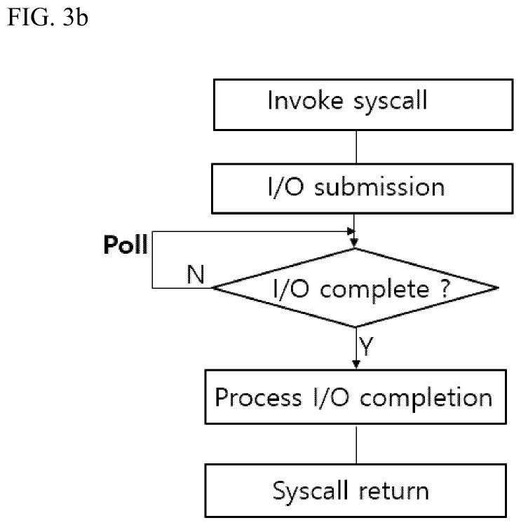

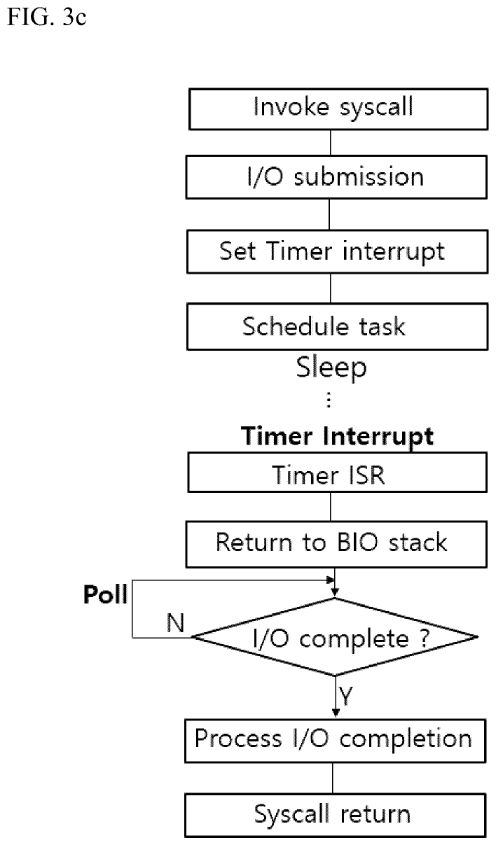

FIGS. 3a to 3c are views describing the operation flows of the interrupt, polling, and hybrid polling.

In the case of the interrupt operation shown in FIG. 3a, the interrupt generated by the SSD upon I/O completion serves as an event that causes the operating system kernel to return to the block I/O (BIO) stack.

On the other hand, in the case of the polling operation shown in FIG. 3b, after I/O submission, the CPU continuously performs polling to check whether the I/O is completed, without task scheduling. Therefore, no separate event is required to return to the BIO stack.

In the case of the hybrid polling operation shown in FIG. 3c, a sleep timer interrupt triggered at the end of the sleep period serves as the event that causes a return to the BIO stack. After returning to the BIO stack, polling is performed until the I/O is completed, as in the polling method.

The present disclosure proposes a new I/O completion detection technique to improve storage device I/O services. The present disclosure addresses the limitation of each method by simultaneously utilizing both the interrupt and hybrid polling within a single I/O command processing procedure. The present disclosure may combine advantages of each method by setting both a device interrupt and a sleep timer interrupt when submitting an I/O to the SSD, and by responding based on the first-received interrupt event.

Hereinafter, a hybrid interrupt processing device and method according to the present disclosure will be described in detail with reference to FIGS. 4 to 8d.

FIG. 4 is a view describing a hybrid interrupt processing system according to the present disclosure.

Referring to FIG. 4, a hybrid interrupt processing system 400 may include a user terminal 410, a hybrid interrupt processing device 430, and an input/output device 450.

The user terminal 410 may correspond to a computing device that may complete task processing according to a task command to the input/output device 450 in conjunction with the hybrid interrupt processing device 430, and may be implemented as a smart phone, a laptop, or a computer. Without being necessarily limited thereto, the user terminal 410 may also be implemented as various devices such as a tablet PC. The user terminal 410 may be connected to the hybrid interrupt processing device 430 through a network, and at least one user terminal 410 may be simultaneously connected to the hybrid interrupt processing device 430. Preferably, the configuration may be implemented inside the user terminal 410. In addition, a dedicated program or application, in conjunction with the hybrid interrupt processing device 430, may be installed and executed in the user terminal 410.

The hybrid interrupt processing device 430 may be implemented as a computing device or a corresponding server that detects a completion time of the task processing according to the task command of the input/output device 450 by applying a method of combining the interrupt and the hybrid polling according to the present disclosure. For example, the hybrid interrupt processing device 430 may include a Linux kernel, which is a computer operating system. The hybrid interrupt processing device 430 may be connected to the user terminal 410 through a network and may exchange related data with the user terminal 410. In addition, the hybrid interrupt processing device 430 may provide at least one task command to the input/output device 450, may detect whether the task processing of the input/output device 450 is completed, and may complete the task command. The hybrid interrupt processing device 430 may detect the completion of the task processing by applying an optimal task processing completion detection technique in accordance with the occurrence order of the interrupt event according to the task command in the process of detecting the completion of the task processing.

The input/output device 450 may correspond to various types of storage devices. The input/output device 450 may be implemented as a volatile or nonvolatile memory and may be used to store all data required for executing an application of the user terminal 410. For example, the input/output device 450 may correspond to an SSD.

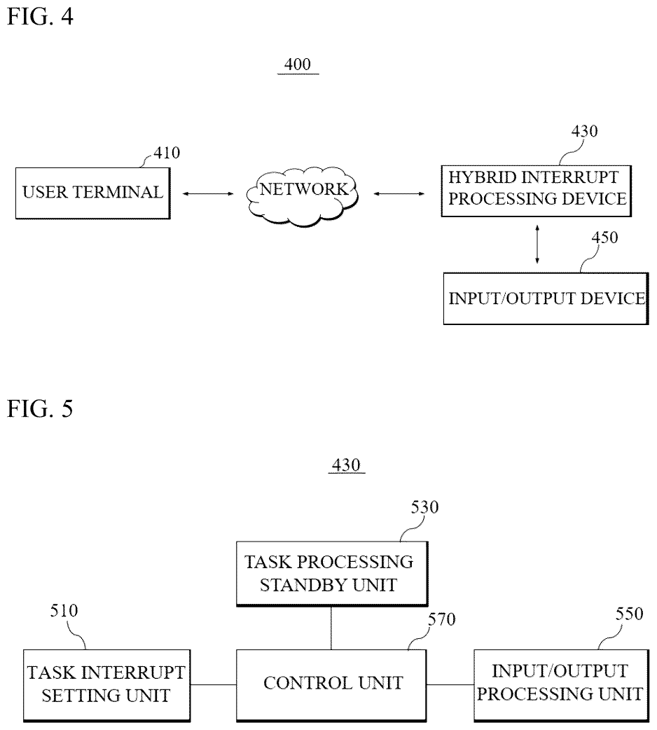

FIG. 5 is a view describing a functional configuration of the hybrid interrupt processing device in FIG. 4.

Referring to FIG. 5, the hybrid interrupt processing device 430 may implement a hybrid interrupt processing technique for checking whether task processing is effectively completed in response to rapid changes in the task processing time of the input/output device 450, and may include a task interrupt setting unit 510, a task processing standby unit 530, an input/output processing unit 550, and a control unit 570.

The task interrupt setting unit 510 may set reception of the device interrupt generated by the input/output device 450 during the process of providing the task command to the input/output device 450 and the reception of the sleep timer interrupt. Here, the input/output device 450 may correspond to a storage device, and in this case, the task command may correspond to an input/output command requesting input/output (I/O) to the storage device. The device interrupt may be generated when the task processing according to the task command is completed in the input/output device 450. The sleep timer interrupt may be generated when a sleep duration set in the sleep timer ends.

In one embodiment, the task interrupt setting unit 510 may first set the reception of the device interrupt, may subsequently set the reception of the sleep timer interrupt, and thereafter, may initiate sleep.

The task processing standby unit 530 may wait for the occurrence of the device interrupt from the input/output device 450 and the sleep timer interrupt from the sleep timer, and may deliver the first-received interrupt event—either a device interrupt or a sleep timer interrupt—to the input/output processing unit 550. In one embodiment, the task processing standby unit 530 may wait for the occurrence of the device interrupt and the sleep timer interrupt, which are set when sleep is initiated.

The input/output processing unit 550 may complete the task processing according to the task command based on the first-received interrupt event—either a device interrupt or a sleep timer interrupt—and may block the second interrupt event which has not yet occurred.

When the first-received interrupt event is the device interrupt, the input/output processing unit 550 may cancel the sleep timer interrupt, which would otherwise cause the second interrupt event. In one embodiment, if the task processing is completed in the input/output device 450 before the sleep ends and the device interrupt of the input/output device 450 is received before the occurrence of the sleep timer interrupt, the input/output processing unit 550 may cancel the sleep timer and then complete the task command. In this manner, the input/output processing unit 550 may prevent a future, unnecessary call of the sleep timer interrupt service routine.

When the first-received interrupt event is the sleep timer interrupt, the input/output processing unit 550 may block the reception of the device interrupt corresponding to the second interrupt event. In one embodiment, when the sleep timer interrupt is received before the device interrupt, the input/output processing unit 550 may prevent an unnecessary call of the device interrupt service routine of the input/output device 450 at the completion time of the task processing of the input/output device 450 in a process of performing the polling on whether the task of the input/output device 450 is completed and completing the task command. For this purpose, even if the device interrupt corresponding to the second interrupt event is received, the input/output processing unit 550 may disable the corresponding device interrupt or may issue a cancel command for the device interrupt to the input/output device 450. Here, the cancel command for the device interrupt may correspond to a command defined not to transmit a task completion interrupt from the input/output device 450 while maintaining the execution of the I/O command submitted to the input/output device 450. In one embodiment, the input/output processing unit 550 may perform polling. When the maximum poll duration elapses, the input/output processing unit 550 may stop polling and re-enable the reception of the device interrupt of the input/output device 450. Here, when the maximum poll duration elapses, the input/output processing unit 550 may stop polling and re-enable the reception of the device interrupt corresponding to the second interrupt event, and may wait for the reception of the device interrupt. When the device interrupt corresponding to the second interrupt event is received, the input/output processing unit 550 may complete the task command.

The control unit 570 may control an overall operation of the hybrid interrupt processing device 430, and may manage the control flow or data flow between the task interrupt setting unit 510, the task processing standby unit 530, and the input/output processing unit 550.

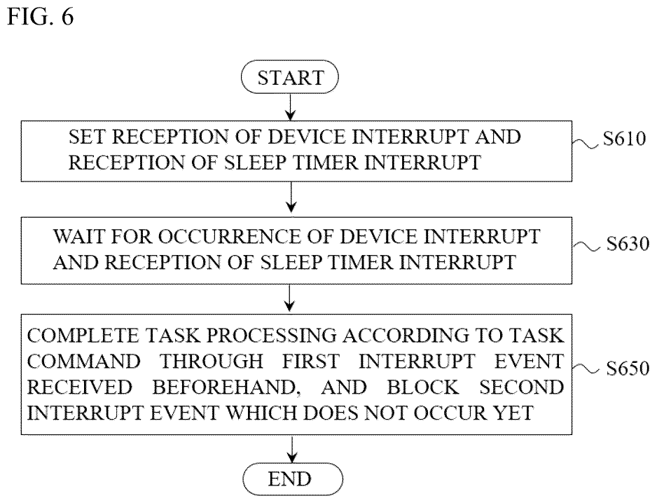

FIG. 6 is a flowchart for describing the hybrid interrupt processing method according to the present disclosure.

Referring to FIG. 6, the hybrid interrupt processing device 430 may set the reception of the device interrupt of the input/output device 450 and the sleep timer interrupt during a process of providing the task command to the input/output device 450 through the task interrupt setting unit 510 (Step S610). The hybrid interrupt processing device 430 may wait for the occurrence of the device interrupt of the input/output device 450 and the sleep timer interrupt through the task processing standby unit 530 (Step S630).

In addition, the hybrid interrupt processing device 430 may complete the task processing according to the task command through the first-received interrupt event—either the device interrupt or the sleep timer interrupt—through the input/output processing unit 550, and may block the second interrupt event that has not yet occurred (Step S650). Here, when the first-received interrupt event is the device interrupt, the input/output processing unit 550 may cancel the sleep timer interrupt corresponding to the second interrupt event. When the first-received interrupt event is the sleep timer interrupt, the input/output processing unit 550 may disable the reception of the device interrupt corresponding to the second interrupt event or may provide a cancel command for the device interrupt corresponding to the second interrupt event to the input/output device 450. Through this configuration, an unnecessary call to an interrupt service routine for the second interrupt event may be prevented.

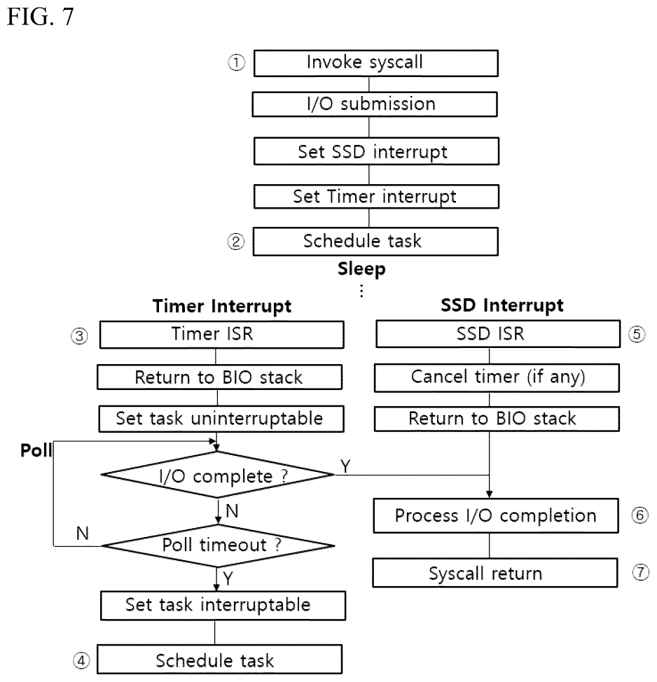

FIG. 7 is a view illustrating an example of a hybrid interrupt processing procedure according to the present disclosure.

Referring to FIG. 7, the hybrid interrupt processing device 430 may be implemented as a processor such as a CPU. The input/output device 450 may correspond to a storage device such as an SSD. The hybrid interrupt processing device 430 may set the reception of the device interrupt from the storage device and the sleep timer interrupt, and may initiate the sleep (\textcircled{1}-\textcircled{2}).

During the sleep, the hybrid interrupt processing device 430 may complete the task processing according to the task command through the first-received interrupt event—either the device interrupt or the sleep timer interrupt.

When the first-received interrupt event is the sleep timer interrupt, the hybrid interrupt processing device 430 may complete the task processing in the order of \textcircled{3}-\textcircled{6}-\textcircled{7}, in the same manner as hybrid polling. Here, this method is referred to as the sleep and poll (SP) method. That is, according to the SP method, the process sleeps during the sleep duration and then returns to the BIO stack to perform polling on whether the input/output (I/O) task of the storage device is completed. In this manner, at the time of I/O completion of the storage device, an unnecessary call of the device interrupt service routine of the storage device is prevented by blocking the device interrupt from the storage device during polling.

When the first-received interrupt event is the device interrupt of the storage device, the hybrid interrupt processing device 430 may complete the task processing in the order of \textcircled{5}-\textcircled{6}-\textcircled{7}. Here, this method is referred to as the sleep and interrupt (SI) method. That is, the SI method calls the device interrupt service routine of the storage device and cancels the interrupt occurrence of the sleep timer, which is still in progress at that time, thereby preventing a future unnecessary call of the sleep timer interrupt service routine. The SI method returns to the block layer of the kernel through the device interrupt service routine of the storage device, completes the task processing, and resume the original user process in which the task is generated.

When a predefined maximum poll duration is exceeded during the polling process in the SP method, the hybrid interrupt processing device 430 may stop the polling to prevent an increase in CPU usage due to excessive polling, and may release the block on the reception of the device interrupt. Thereafter, the hybrid interrupt processing device 430 may wait for the occurrence of the device interrupt from the storage device and may complete the task processing in the order of \textcircled{3}-\textcircled{4}-\textcircled{5}-\textcircled{6}-\textcircled{7}. Here, this method is referred to as the sleep, poll, and interrupt (SPI) method.

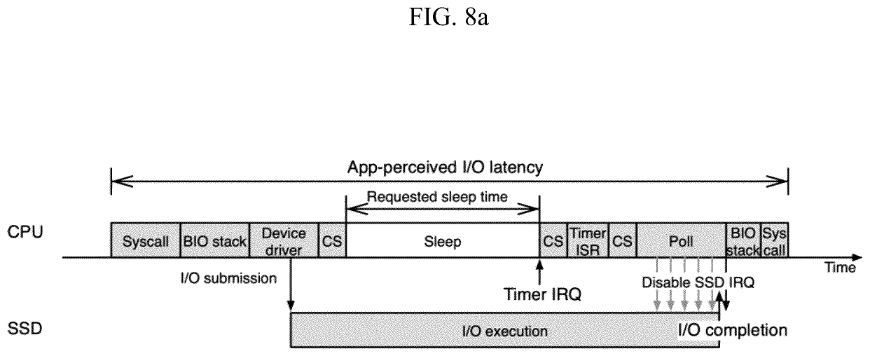

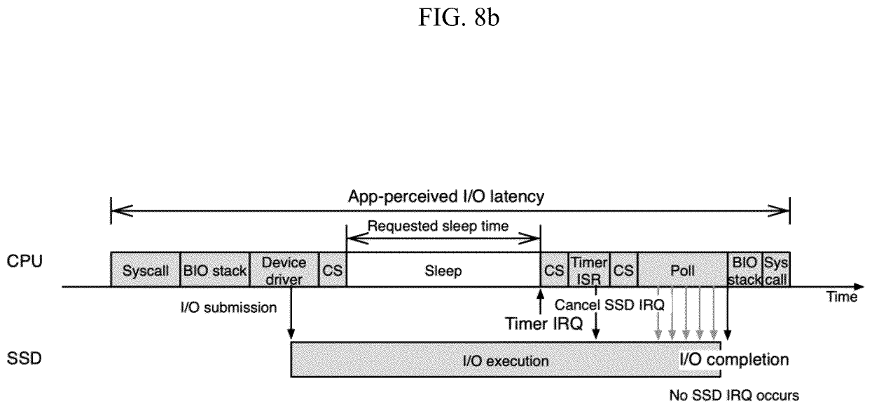

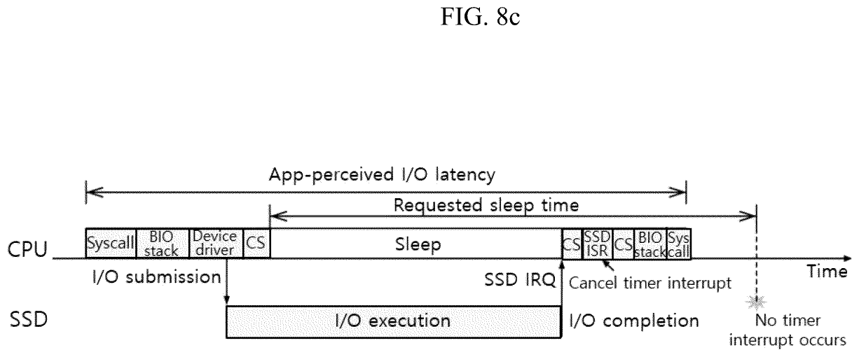

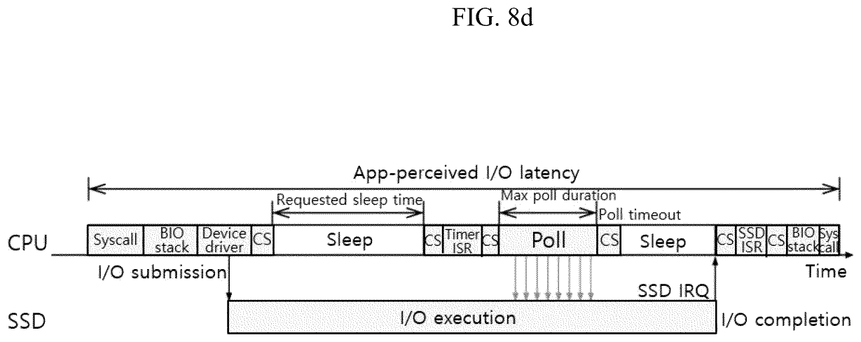

FIGS. 8a to 8d are views for describing operations according to each interrupt processing method in FIG. 7.

Referring to FIGS. 8a to 8d, in the I/O request process, after the I/O command is transmitted to the storage device, a sleep timer function is called to switch the process to an idle state for a predetermined period of time. Immediately after the process wakes up by the sleep timer interrupt, the I/O request process operates using the sleep and poll (SP) method, as illustrated in FIGS. 8a and 8b, and performs polling by repeatedly checking whether the I/O of the storage device is completed. That is, the SP method may check whether the I/O is completed by using the hybrid polling method in which the process sleeps during the sleep duration and then performs polling to check whether the input/output of the storage device is completed. When the sleep timer interrupt event occurs before the device interrupt from the storage device, the reception of the device interrupt is disabled while polling is performed (FIG. 8a), or a device interrupt cancel command is issued to the storage device to suppress the transmission of the device interrupt (FIG. 8b).

When the I/O is completed in the storage device and the device interrupt occurs before the sleep timer interrupt, the sleep timer interrupt is canceled by the operation using the sleep and interrupt (SI) method, as illustrated in FIG. 8c. The process returns to the BIO stack of the kernel through the device interrupt service routine (ISR) of the storage device. That is, the SI method may detect I/O completion through the device interrupt even when the I/O is completed before the process wakes up from sleep. Therefore, the SI method may prevent oversleep, in which the process wakes up later than the actual I/O completion time.

When the maximum poll duration is exceeded during the polling process in the SP method, the sleep, poll and interrupt (SPI) method may be used, as illustrated in FIG. 8d, to stop the polling and to release CPU occupation. Thereafter, the SPI method may detect I/O completion using the interrupt method, in which the process waits for the device interrupt that occurs upon I/O completion in the storage device. The SPI method may prevent increased CPU usage caused by an excessively long poll duration in case of undersleep, where the process wakes up earlier than the actual I/O completion time.

The hybrid interrupt processing device and method according to the present disclosure may effectively prevent excessive undersleeping and oversleeping, which can result from failures in predicting the appropriate sleep duration of the hybrid polling technique due to rapid changes in the I/O processing time of the I/O device, unstable operation of the sleep timer interrupt, or similar issues. Therefore, the overall I/O service of the I/O device may be enhanced, leading to improvements in average I/O latency, reduced CPU usage, and lower I/O tail latency.

Although the present disclosure has been described above with reference to the preferred embodiments, it will be understood by those skilled in the art that the present disclosure may be corrected and modified in various ways within the scope not departing from the idea and the scope of the present disclosure in the appended claims.

[DESCRIPTION OF REFERENCE NUMERALS]

| | |
|---|---|
| 400: hybrid interrupt processing system | |
| 410: user terminal | |
| 430: hybrid interrupt processing device | |
| 450: input/output device | |
| 510: task interrupt setting unit | 530: task processing standby |
| | unit |
| 550: input/output processing unit | 570: control unit |

1. A hybrid interrupt processing device comprising:
a task interrupt setting unit that sets reception of a device interrupt generated by an input/output device and reception of a sleep timer interrupt during a process of providing a task command to the input/output device;
a task processing standby unit that waits for occurrence of the device interrupt and the sleep timer interrupt; and
an input/output processing unit that completes task processing according to the task command based on a first-received interrupt event—either the device interrupt or the sleep timer interrupt—and blocks a second interrupt event that has not yet occurred.

2. The hybrid interrupt processing device of claim 1, wherein the task interrupt setting unit first sets reception of the device interrupt, subsequently sets reception of the sleep timer interrupt, and thereafter initiates sleep.

3. The hybrid interrupt processing device of claim 1, wherein the task processing standby unit waits for occurrence of the device interrupt and the sleep timer interrupt, and delivers the first-received interrupt event—either the device interrupt or the sleep timer interrupt—to the input/output processing unit.

4. The hybrid interrupt processing device of claim 1, wherein when the first-received interrupt event is the device interrupt, the input/output processing unit cancels the sleep timer interrupt corresponding to the second interrupt event.

5. The hybrid interrupt processing device of claim 4, wherein when the device interrupt is first received before occurrence of the sleep timer interrupt, the input/output processing unit cancels the sleep timer and, thereafter, completes the task command to prevent a call of a sleep timer interrupt service routine.

6. The hybrid interrupt processing device of claim 1, wherein when the first-received interrupt event is the sleep timer interrupt, the input/output processing unit disables reception of the device interrupt corresponding to the second interrupt event.

7. The hybrid interrupt processing device of claim 1, wherein when the first-received interrupt event is the sleep timer interrupt, the input/output processing unit provides a cancellation command for the device interrupt corresponding to the second interrupt event to the input/output device.

8. The hybrid interrupt processing device of claim 1, wherein when the first-received interrupt event is the sleep timer interrupt, the input/output processing unit performs polling to determine whether a task of the input/output device is completed.

9. The hybrid interrupt processing device of claim 8, wherein when a maximum poll duration elapses during the polling, the input/output processing unit stops the polling and re-enables reception of the device interrupt.

10. A hybrid interrupt processing method comprising:
a task interrupt setting step of setting reception of a device interrupt generated by an input/output device and reception of a sleep timer interrupt during a process of providing a task command to the input/output device;
a task processing standby step of waiting for occurrence of the device interrupt and the sleep timer interrupt; and
an input/output processing step of completing task processing according to the task command through a first-received interrupt event—either the device interrupt or the sleep timer interrupt—and blocking a second interrupt event that has not yet occurred.

11. The hybrid interrupt processing method of claim 10, wherein in the task interrupt setting step, reception of the device interrupt is first set, reception of the sleep timer interrupt is subsequently set, and thereafter, sleep is initiated.

12. The hybrid interrupt processing method of claim 10, wherein in the task processing standby step, occurrence of the device interrupt and the sleep timer interrupt is waited for, and thereafter, the first-received interrupt event—either the device interrupt or the sleep timer interrupt—is delivered to the input/output processing unit.

13. The hybrid interrupt processing method of claim 10, wherein in the input/output processing step, when the first-received interrupt event is the device interrupt, the sleep timer interrupt corresponding to the second interrupt event is cancelled.

14. The hybrid interrupt processing method of claim 10, wherein in the input/output processing step, when the first-received interrupt event is the sleep timer interrupt, reception of the device interrupt corresponding to the second interrupt event is disabled.

15. The hybrid interrupt processing method of claim 10, wherein in the input/output processing step, when the first-received interrupt event is the sleep timer interrupt, a cancel command for the device interrupt corresponding to the second interrupt event is issued to the input/output device.

16. The hybrid interrupt processing method of claim 10, wherein in the input/output processing step, when the first-received interrupt event is the sleep timer interrupt, polling is performed to determine whether a task of the input/output device is completed.

17. The hybrid interrupt processing method of claim 16, wherein in the input/output processing step, when a maximum poll duration elapses during the polling, the polling is stopped, and reception of the device interrupt is re-enabled.
